(19) United States
(12) Patent Application Publication
(10) Pub. No.: US 2023/0115854 A1
(43) Pub. Date: Apr. 13, 2023

(54) TRACTION CONTROLLER, TRACTION CONTROL METHOD, AND NON-TRANSITORY COMPUTER-READABLE STORAGE MEDIUM

(71) Applicant: TOYOTA JIDOSHA KABUSHIKI KAISHA, Toyota-shi Aichi-ken (JP)

(72) Inventor: Masamichi Iwama, Gotemba-shi Shizuoka-ken (JP)

(73) Assignee: TOYOTA JIDOSHA KABUSHIKI KAISHA, Toyota-shi Aichi-ken (JP)

(21) Appl. No.: 17/958,738

(22) Filed: Oct. 3, 2022

(30) Foreign Application Priority Data
Oct. 7, 2021 (JP) 2021-165542

(51) Int. Cl. B60L 15/20

(52) U.S. Cl. CPC B60L 15/20; B60L 2240/465; B60L 2240/461; B60L 2240/423; B60L 2260/42

(57) ABSTRACT

A traction controller for an electric vehicle according to the present disclosure calculates a first target torque and a second target torque. The first target torque is a motor torque for achieving a target rotational speed calculated based on a target slip. The second target torque is a motor torque for achieving a target driving force set based on an estimated friction coefficient of a road surface and a ground contact load. The traction controller determines an arbitration target torque with the first target torque as a required value and the second target torque as a constraint condition, and controls the motor based on the arbitration target torque.

### CROSS-REFERENCE TO RELATED APPLICATION

The present application claims priority under 35 U.S.C. § 119 to Japanese Patent Application No. 2021-165542, filed Oct. 7, 2021, the contents of which application are incorporated herein by reference in their entirety.

### BACKGROUND

### Field

The present disclosure relates to a traction controller, a traction control method, and a program for an electric vehicle that drives a wheel by a motor.

### Background Art

A prior art related to traction control of an electric vehicle in which wheels are driven by a motor is disclosed in, for example, U.S. Pat. No. 8,996,221 B2. According to the prior art disclosed in U.S. Pat. No. 8,996,221 B2, a predetermined slip is set depending on the driving situation of each driving axle or each driving wheel. Then, the rotational speed of the motor of each driving axle is controlled according to the set slip.

However, in the traction control of the prior art, an excessive slip due to an excessive driving force or an acceleration failure due to an insufficient driving force may occur.

### SUMMARY

The present disclosure has been made in view of the above-described problem, and an object thereof is to provide a technique capable of preventing an excessive slip due to an excessive driving force or an acceleration failure due to an insufficient driving force in a case where a slip of a vehicle is controlled by a rotational speed of a wheel.

### Means for Solving the Problems

To achieve the above object, the present disclosure provides a traction controller for an electric vehicle. The traction controller of the present disclosure is a traction controller for an electric vehicle that drives a wheel by a motor, and includes at least one memory storing at least one program, and at least one processor coupled to the at least one memory.

In the traction controller of the present disclosure, the at least one program is configured to cause the at least one processor to execute at least the following first to seventh processes. The first process is to set a target slip based on an operating state of the electric vehicle. The second process is to calculate a target rotational speed of the wheel based on the target slip. The third process is to calculate a first target torque that is a motor torque for achieving the target rotational speed. The fourth process is to set a target driving force of the wheel based on an estimated friction coefficient of a road surface and a ground contact load. The fifth process is to calculate a second target torque that is a motor torque for achieving the target driving force. The sixth process is to determine an arbitration target torque with the first target torque as a required value and the second target torque as a constraint condition. The seventh process is to control the motor based on the arbitration target torque.

In the traction controller of the present disclosure, the at least one program may further cause the at least one processor to execute an eighth process. The eighth process is to correct the target driving force based on at least one of a deviation between the target slip and an actual slip and a deviation between a target wheel acceleration calculated from a target wheel speed for achieving the target slip and an actual wheel acceleration.

In the traction controller of the present disclosure, determining the arbitration target torque in the sixth process may include executing a torque upper limit guard. The torque upper limit guard is a process of determining the first target torque as the arbitration target torque when the first target torque is equal to or less than the second target torque, and determining the second target torque as the arbitration target torque when the first target torque is greater than the second target torque.

Calculating the second target torque in the third process may include calculating, as the second target torque, a motor torque for stability control for stabilizing the behavior of the vehicle. In this case, determining the arbitration target torque in the sixth process may include performing the torque upper limit guard in response to intervention of the stability control.

In the traction controller of the present disclosure, determining the arbitration target torque in the sixth process may include executing a torque lower limit guard. The torque lower limit guard is a process of determining the first target torque as the arbitration target torque when the first target torque is equal to or greater than the second target torque, and determining the second target torque as the arbitration target torque when the first target torque is less than the second target torque.

The calculating the target rotational speed in the second process may include calculating, as the target rotational speed, a rotational speed of the wheel required to achieve the target slip based on a measured value or estimated value of a vehicle body speed. In this case, determining the arbitration target torque in the sixth process may include executing the torque lower limit guard in response to the measured value or estimated value of the vehicle body speed used for calculating the target rotational speed not satisfying the allowable accuracy.

The electric vehicle to which the traction controller of the present disclosure is applied may include the motor for each driving axle that transmits a driving force to left and right driving wheels. In this case, the target rotational speed may be calculated for each driving axle, the first target torque may be calculated for each driving axle, the target driving force may be set for each driving axle, the second target torque may be calculated for each driving axle, the arbitration target torque may be determined for each driving axle, and the motor may be controlled for each driving axle.

The electric vehicle to which the traction controller of the present disclosure is applied may include the motor for each driving wheel. In this case, the target rotational speed may be calculated for each driving wheel, the first target torque may be calculated for each driving wheel, the target driving force may be set for each driving wheel, the second target torque may be calculated for each driving wheel, the arbitration target torque may be determined for each driving wheel, and the motor may be controlled for each driving wheel.

To achieve the above object, the present disclosure provides a traction control method for an electric vehicle. The traction control method of the present disclosure is a traction control method for an electric vehicle that drives a wheel by a motor, and includes the following first to seventh steps. The first step is to set a target slip based on an operating state of the electric vehicle. The second step is to calculate a target rotational speed of the wheel based on the target slip. The third step is to calculate a first target torque that is a motor torque for achieving the target rotational speed. The fourth step is to set a target driving force of the wheel based on an estimated friction coefficient of a road surface and a ground contact load. The fifth step is to calculate a second target torque which is a motor torque for achieving the target driving force. The sixth step is to determine an arbitration target torque with the first target torque as a required value and the second target torque as a constraint condition. The second step is to control the motor based on the arbitration target torque.

To achieve the above object, the present disclosure provides a program that is stored in a non-transitory computer-readable storage medium. The program according to the present disclosure is a program for controlling a motor torque of an electric vehicle that drives a wheel by a motor, and is configured to cause a computer to execute processing comprising the following first to seventh processes. The first process is to set a target slip based on an operating state of the electric vehicle. The second process is to calculate a target rotational speed of the wheel based on the target slip. The third process is to calculate a first target torque that is a motor torque for achieving the target rotational speed. The fourth process is to set a target driving force of the wheel based on an estimated friction coefficient of a road surface and the ground contact load. The fifth process is to calculate a second target torque that is a motor torque for achieving the target driving force. The sixth process is to determine an arbitration target torque with the first target torque as a required value and the second target torque as a constraint condition. The seventh process is to control the motor based on the arbitration target torque.

As described above, according to the techniques of the present disclosure, the first target torque and the second target torque are calculated. The first target torque is a motor torque for achieving the target rotational speed calculated based on the target slip. The second target torque is a motor torque for achieving the target driving force set based on the estimated friction coefficient of the road surface. According to the techniques of the present disclosure, the arbitration target torque is determined with the first target torque as the required value and the second target torque as the constraint condition, and the motor is controlled based on the arbitration target torque. By executing such torque arbitration, when the slip of the electric vehicle is controlled by the rotational speed of the wheel, it is possible to prevent an excessive slip due to an excessive driving force and an acceleration failure due to an insufficient driving force.

### BRIEF DESCRIPTION OF THE DRAWINGS

FIG. 1 is a diagram for explaining a specific example of torque arbitration by a traction controller and traction control method of the present disclosure.

FIG. 2 is a diagram for explaining a specific example of torque arbitration by the traction controller and traction control method of the present disclosure.

FIG. 3 is a diagram showing a configuration of an electric vehicle to which a traction controller according to a first embodiment of the present disclosure is applied.

FIG. 4 is a flowchart of a first traction control method executed in the electric vehicle having the configuration shown in FIG. 3.

FIG. 5 is a flowchart of a second traction control method executed in the electric vehicle having the configuration shown in FIG. 3.

FIG. 6 is a diagram showing a configuration of an electric vehicle to which a traction controller according to a second embodiment of the present disclosure is applied.

FIG. 7 is a flowchart of a third traction control method executed in the electric vehicle having the configuration shown in FIG. 6.

FIG. 8 is a flowchart of a fourth traction control method executed in the electric vehicle having the configuration shown in FIG. 6.

FIG. 9 is diagram for explaining another example of traction control that can be executed in the electric vehicle having the configuration shown in FIG. 3 and the electric vehicle having the configuration shown in FIG. 6.

### DETAILED DESCRIPTION

Hereinafter, embodiments of the present disclosure will be described with reference to the drawings. However, in the embodiments described below, when a numerical value such as the number, quantity, amount, range, or the like of each element is mentioned, the idea according to the present disclosure is not limited to the mentioned numerical value except for a case where the numerical value is clearly specified in particular or a case where the numerical value is obviously specified to the numerical value in principle. In addition, a structure, step or the like described in the following embodiments is not necessarily essential to the idea according to the present disclosure except for a case where the structure, step or the like is clearly specified in particular or a case where the structure, step or the like is obviously specified in principle.

### 1. Overview of Traction Control

A traction controller and traction control method of the present disclosure are applied to an electric vehicle that drives a wheel by a motor. Traction control is performed in order to suppress disturbance of the behavior of a vehicle due to slipping of a wheel. In the case of the electric vehicle, slipping of the wheel can be suppressed by controlling the rotational speed of the wheel by the motor.

One method for traction control for the electric vehicle is to control the rotational speed of the wheel with the control target of maintaining the target slip. However, in this case, as exemplified below, there is a risk of an excessive slip due to an excessive driving force, or an acceleration failure due to an insufficient driving force.

### Example 1

When the target rotational speed of the wheel is set based on the target slip, information on the vehicle body speed serving as a reference is required. When the estimated vehicle body speed obtained from the speed information is higher than the actual speed, the target rotational speed calculated from the target slip and the estimated vehicle body speed becomes larger than a truly required value. Since the motor generates torque so that the actual rotational speed becomes the target rotational speed, when the target rotational speed becomes excessive, the torque generated by the motor also becomes excessive, and an excessive driving force acts on the wheel to generate an excessive slip.

### Example 2

When slipping of a wheel occurs during traveling on an uphill road having a low road surface friction coefficient, the method of controlling the rotational speed of the wheel so as to maintain the target slip may apply a driving force greater than the road surface friction coefficient from the motor to the wheel. In this case, the slipping of the wheel does not stop, and this makes difficult for the vehicle to climb the uphill road.

### Example 3

When the estimated vehicle body speed obtained from the speed information is lower than the actual speed, the target rotational speed calculated from the target slip and the estimated vehicle body speed becomes smaller than a truly required value. Since the motor generates torque so that the actual rotational speed becomes the target rotational speed, when the target rotational speed becomes insufficient, the torque generated by the motor also becomes insufficient, and an acceleration failure occurs due to an insufficient driving force.

### Example 4

When trying to escape from a stack, it is necessary to apply a large driving force to the wheel to generate a certain amount of slip. However, the method of controlling the rotational speed of the wheel so as to maintain the target slip, when the slip becomes large, makes it difficult for the vehicle to escape from the stack because the driving force is reduced so as not to exceed the target slip. As a countermeasure for such a case, it is conceivable to temporarily limit the traction control by a switch operation. However, when the traction control is limited, there is a risk that the slip becomes excessive after the vehicle escapes from the stack and the stability of the vehicle is lost.

### Example 5

In a vehicle in which right and left axles are connected via a differential gear, a road surface friction coefficient between a driving wheel on one side and a road surface may become significantly low. In such a case, the method of controlling the rotational speed of the wheel so as to maintain the target slip causes an acceleration failure since the driving force is greatly reduced.

In addition to the above-described examples, there is an example in which the rotational speed of the wheel is controlled so as to maintain the target slip, and as a result, the longitudinal force of the tire cannot be maximized, and an acceleration failure occurs.

The deviation of the reference vehicle body speed from the actual vehicle body speed described in Examples 1 and 3 may be caused by several factors as follows. First, in the case where the vehicle body speed is estimated from the wheel speed, the deviation of the vehicle body speed may occur when a four-wheel spin occurs in a four-wheel drive vehicle or when a four-wheel lock occurs due to braking on a low friction coefficient road. Further, when the vehicle body speed is estimated from an acceleration sensor, a change in road surface gradient or an error in a sensor value is considered as a cause of the deviation of the vehicle body speed. When the vehicle body speed is estimated using a GPS signal, the deviation of the vehicle body speed may occur at the time of passing through a sky blocking object.

To address the above issues, the traction controller and traction control method of the present disclosure employs a method of combining rotational speed control for controlling the rotational speed of the wheel based on the target slip and torque control based on an estimated friction coefficient of the road surface.

In the rotational speed control, first, the target slip is set based on the operating state of the vehicle, and then a target rotational speed of the wheel is calculated based on the target slip. Then, a rotational speed control target torque (first target torque) that is a motor torque for achieving the target rotational speed is calculated. On the other hand, in the torque control, first, a target driving force of the wheel is set based on the estimated friction coefficient of the road surface and a ground contact load. Next, an instruction torque (second target torque) that is a motor torque for achieving the target driving force is calculated.

As described above, the rotational speed control target torque is calculated in the rotational speed control, and the instruction torque is calculated in the torque control. The rotational speed control target torque is a motor torque for maintaining the target slip. The instruction torque is a motor torque for maintaining the driving force applied from the motor to the vehicle at an appropriate value that does not cause insufficient acceleration and slipping of the vehicle. In the traction controller and traction control method of the present disclosure, these two types of torques are arbitrated, and the arbitrated torque (arbitration target torque) is commanded to the motor as a motor execution torque.

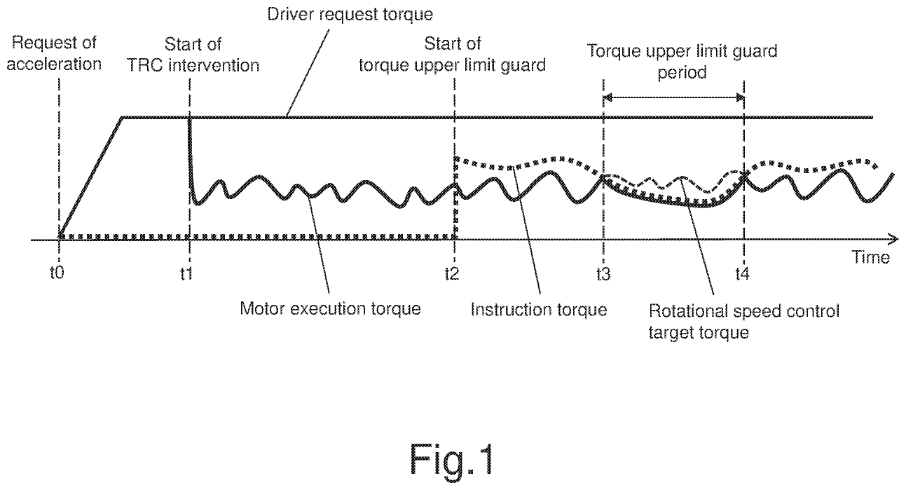

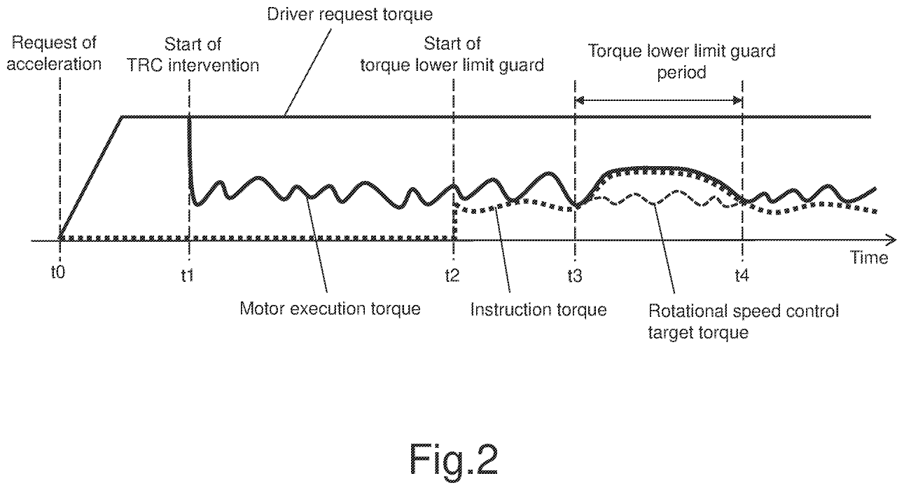

In the torque arbitration by the traction controller and traction control method according to the present disclosure, the motor execution torque is determined with the rotational speed control target torque as a required value and the instruction torque as a constraint condition. The torque arbitration includes a torque upper limit guard and a torque lower limit guard. The torque upper limit guard is a process of outputting the rotational speed control target torque as the motor execution torque when the rotational speed control target torque is equal to or less than the instruction torque, and outputting the instruction torque as the motor execution torque when the rotational speed control target torque is greater than the instruction torque. The torque lower limit guard is a process of outputting the rotational speed control target torque as the motor execution torque when the rotational speed control target torque is equal to or greater than the instruction torque, and outputting the instruction torque as the motor execution torque when the rotational speed control target torque is less than the instruction torque. A specific example of the torque upper limit guard is shown in FIG. 1, and a specific example of the torque lower limit guard is shown in FIG. 2.

In each of the examples shown in FIGS. 1 and 2, the accelerator pedal is depressed by the driver at time t0 and acceleration is requested from the vehicle. In response to the acceleration request, the driver request torque increases. In each of the examples shown in FIGS. 1 and 2, the traction control (TRC) intervenes at time t1 after the driver request torque reaches the maximum value. The intervention of the traction control is carried out, for example, when wheel slip is detected or estimated.

With the intervention of the traction control, the torque of the motor is feedback-controlled so that the actual rotational speed of the wheel coincides with the target rotational speed. The target torque in this feedback control is the rotational speed control target torque. During a period until the torque upper limit guard or the torque lower limit guard is started, the rotational speed control target torque obtained by the feedback control is used as the motor execution torque.

In the example shown in FIG. 1, the torque upper limit guard is started at time t2 after the start of the traction control. Even in a period in which the torque upper limit guard is executed, if the rotational speed control target torque is equal to or less than the instruction torque, the rotational speed control target torque is output as the motor execution torque. However, from time t3 to time t4 when the rotational speed control target torque exceeds the instruction torque, the instruction torque is output as the motor execution torque instead of the rotational speed control target torque.

The torque upper limit guard is executed in response to execution of stability control for stabilizing the behavior of the vehicle, for example. The stability control is a control for controlling the braking/driving force of each wheel to suppress skidding of the vehicle and stabilize the behavior of the vehicle. The instruction torque outputted during the torque upper limit guard is an upper limit torque capable of suppressing the skidding which is specified in the stability control of the vehicle. By executing the torque upper limit guard, it is possible to suppress the occurrence of an excessive slip due to an excessive driving force acting on the wheel, and to stabilize the behavior of the vehicle.

In the example shown in FIG. 2, the torque lower limit guard is started at time t2 after the start of the traction control. Even in a period in which the torque lower limit guard is executed, if the rotational speed control target torque is equal to or greater than the instruction torque, the rotational speed control target torque is output as the motor execution torque. However, from time t3 to time t4 when the rotational speed control target torque is less than the instruction torque, the instruction torque is output as the motor execution torque instead of the rotational speed control target torque.

The torque lower limit guard is executed when, for example, a measured value or estimated value of the vehicle body speed does not satisfy allowable accuracy. The measured or estimated value of the vehicle speed is used to calculate the target rotational speed. Specifically, since the difference between the vehicle body speed and the wheel speed is the slip, and the quotient of the wheel speed and the tire radius is the rotational speed, the target rotational speed in the rotational speed control is calculated from the target slip based on the vehicle body speed. Therefore, a decrease in the accuracy of the measured value or estimated value of the vehicle body speed also decreases the accuracy of the target rotational speed. If the target rotational speed is set to an insufficient value, the motor execution torque also becomes insufficient, and an acceleration failure occurs due to an insufficient driving force. However, if the torque at which the minimum acceleration can be obtained is set as the instruction torque of the torque lower limit guard, it is possible to prevent the torque from being greatly reduced and to suppress the occurrence of the acceleration failure.

According to the traction controller and traction control method of the present disclosure, the above-described torque arbitration is executed when the traction control is executed, thereby preventing an excessive slip due to an excessive driving force and an acceleration failure due to an insufficient driving force.

### 2. First Embodiment

2-1. Configuration of Electric Vehicle to which Traction Controller is Applied

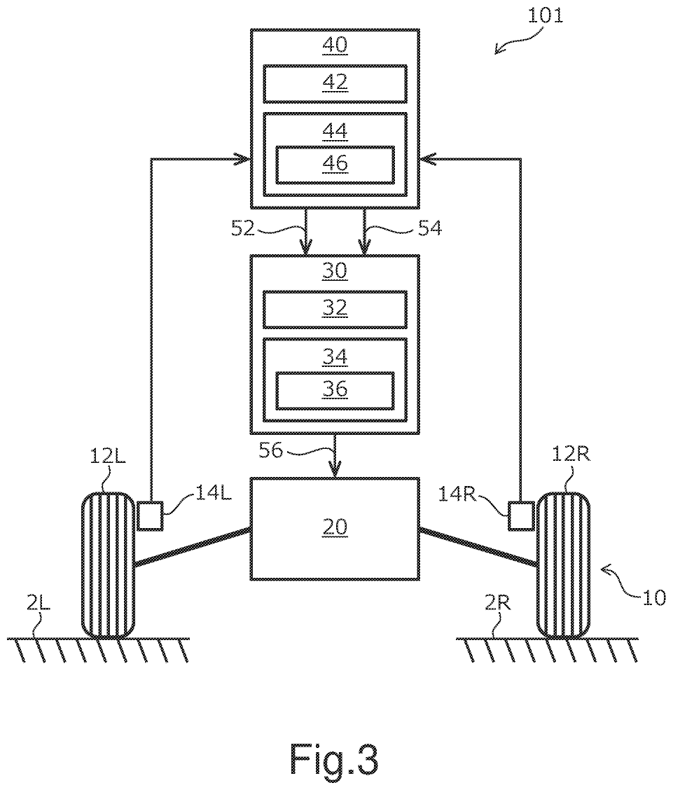

First, a configuration of an electric vehicle to which a traction controller according to the first embodiment of the present disclosure is applied will be described with reference to FIG. 3.

The vehicle 101 shown in FIG. 3 is an electric vehicle. The electric vehicle includes BEV, FCEV, PHEV, and HEV. The type of the electric vehicle used as the vehicle 101 is not limited as long as the electric vehicle is capable of driving a wheel by a motor and executing the above-described traction control by the motor.

The vehicle 101 is configured such that left and right wheels (driving wheels) 12L and 12R grounded on road surfaces 2L and 2R are driven by a single motor 20. A reduction gear and a differential gear (not shown) are provided between the motor 20 and the left and right wheels 12L and 12R. The driving axle 10 provided with the wheels 12L and 12R may be a front axle or a rear axle. Further, both the front axle and the rear axle may be driving axles. In this case, a motor is provided for each of the drive axles, the front axle and the rear axle. Alternatively, the torque of one motor may be distributed to the front axle and the rear axle by a torque dividing mechanism.

The vehicle 101 includes a vehicle controller 40 and a motor controller 30. Each of the vehicle controller 40 and the motor controller 30 is configured by an on-board computer, for example, an electronic control unit (ECU). The vehicle controller 40 and the motor controller 30 are connected by an in-vehicle network system such as a CAN (Car Area Network). In addition, the vehicle 101 includes wheel speed sensors 14L and 14R for detecting wheel speeds of all wheels including the wheels 12L and 12R. The wheel speed sensors 14L and 14R as well as other sensors are connected to the vehicle controller 40 by the in-vehicle network system.

The vehicle controller 40 includes a memory 44 storing a program 46 and a processor 42 coupled to the memory 44 by a bus (not shown). The motor controller 30 includes a memory 34 storing a program 36 and a processor 32 coupled to the memory 34 by a bus (not shown). The program 46 includes programs for the rotational speed control and torque control described above. The program 36 includes a program for the torque arbitration described above. The rotational speed control program and torque control program included in the program 46 are executed by the processor 42, and the torque arbitration program included in the program 36 is executed by the processor 32, whereby the above-described traction control is achieved.

The vehicle controller 40 and the motor controller 30 constitute a traction controller according to the first embodiment. A target rotational speed 52 for rotational speed control and an instruction torque 54 for torque control are input from the vehicle controller 40 to the motor controller 30. A motor execution torque 56 obtained by the torque arbitration is input from the motor controller 30 to the motor 20. The motor 20 operates in accordance with the motor execution torque 56 input from the motor controller 30, and generates a torque corresponding to the motor execution torque 56.

### 2-2. First Traction Control Method

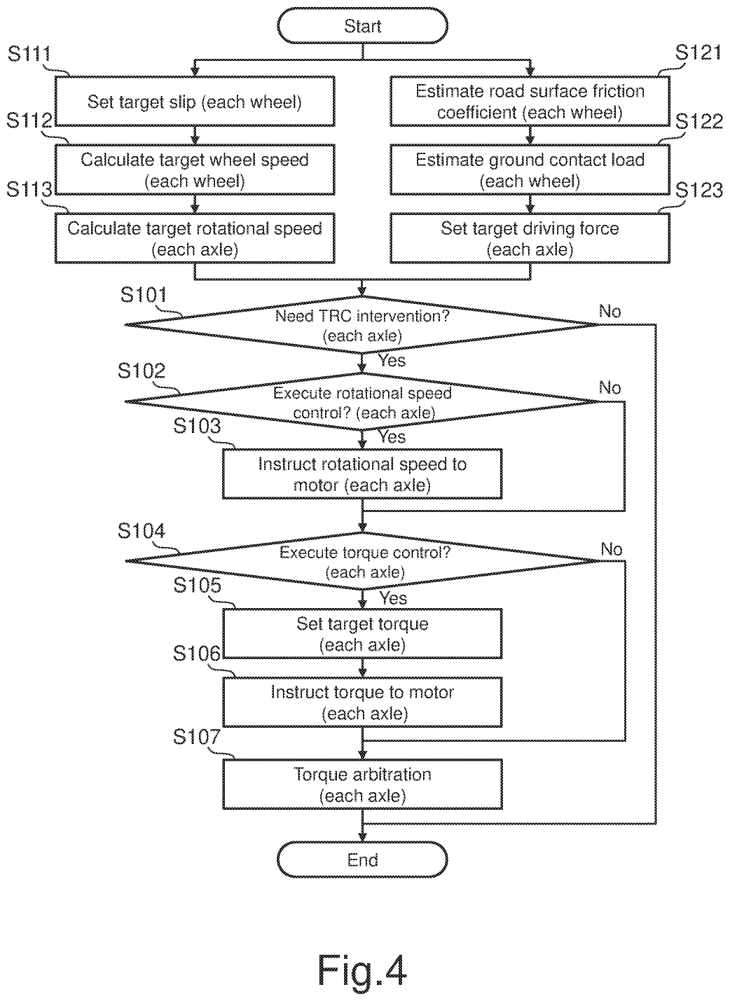

The first traction control method is an example of a specific method for executing the above-described traction control in the vehicle 101 having the configuration shown in FIG. 3. FIG. 4 is a flowchart of the first traction control method.

In step S111 of the flowchart, the target slip is set in accordance with the operating state of the vehicle 101. For example, when the vehicle speed is high, the target slip is increased, and when the vehicle is turning, the target slip is decreased. Further, the target slip may be made different between when the wheels 12L and 12R vibrate as in the case of running on a rough road and when the wheels 12L and 12R do not vibrate. Further, the target slip may be different between when the accelerator pedal is depressed and when the accelerator pedal is not depressed. The target slip is set for each of the wheels 12L and 12R. For example, first, the target slip of a reference wheel is set, and then, the target slips of other wheels are set based on the target slip of the reference wheel and the motion state of the vehicle 101.

In step S112, the target wheel speed is calculated based on the target slip set in step S111. The target wheel speed of each wheel is obtained by adding a value obtained by converting the vehicle body speed into the wheel speed of each wheel 12L and 12R to the target slip of each wheel 12L and 12R. For example, when the target slip of the left wheel 12L is 1 m/s and the vehicle body speed is 10 m/s, the target wheel speed of the left wheel 12L is 11 m/s.

In step S113, the average value of the target wheel speed of the left wheel 12L and target wheel speed of the right wheel 12R calculated in step S112 is calculated. Then, the target rotational speed of the driving axle 10 is calculated from the average value of the target wheel speeds and the wheel radius. In the case of a vehicle in which both the front axle and the rear axle are driving axles, the average value of the target wheel speeds of the left and right wheels of the front axle and the average value of the target wheel speeds of the left and right wheels of the rear axle are calculated, respectively. Then, the target rotational speed is calculated for each driving axle from the average value of the target wheel speeds for each driving axle and the wheel radius.

In step S121 of the flowchart, road surface friction coefficients between the wheels 12L and 12R and the road surfaces 2L and 2R are estimated. The road surface friction coefficient can be estimated from, for example, a sensor value of an acceleration sensor and a slip state. Further, the road surface friction coefficient may be estimated from big data that can be acquired by mobile communication or preceding vehicle information that can be acquired by vehicle-to-vehicle communication.

In step S122, ground contact loads between the wheels 12L and 12R and the road surfaces 2L and 2R are estimated. The ground contact load is estimated based on a change in axle load estimated from the weight of the vehicle, the wheelbase of the vehicle, the height of the gravity center of the vehicle, a sensor value of an acceleration sensor, and the like. The axle load may not be an estimated value but may be a measured value measured using a load sensor provided for each axle.

In step S123, first, the available longitudinal force for each of the wheels 12L and 12R is estimated based on the road surface friction coefficients estimated in step S121 and the ground contact loads estimated in step S122. Next, the target driving force for each of the wheels 12L and 12R is set based on the available longitudinal force, the driver request driving force, and the vehicle state. Then, the larger one of the target driving forces for the left and right wheels 12L and 12R is set as the target driving force for the driving axle 10. In the case of a vehicle in which both the front axle and the rear axle are driving axles, the target driving force is set for each driving axle.

According to the flowchart, the group of processes from step S111 to step S113 for calculating the target rotational speed for each driving axle and the group of processes from step S121 to step S123 for setting the target driving force for each driving axle are executed in parallel. However, it is also possible to execute one group of processes in advance and execute the other group of processes thereafter.

Next, in step S101 of the flowchart, the start and end of the intervention of the traction control are determined based on the slip states of the wheels 12L and 12R. The start of the intervention of the traction control is determined by whether or not the wheel 12L and 12R are slipping. For example, the intervention of the traction control is started when the slip of at least one of the left and right wheels 12L and 12R becomes greater than a first predetermined value. On the other hand, the end of the intervention of the traction control is determined based on whether or not the slipping of all the wheels 12L and 12R has ended. For example, when the slips of the wheels 12L and 12R are less than a second reference value smaller than the first reference value and the traction control becomes unnecessary, the intervention of the traction control is ended. When the intervention of the traction control is unnecessary, the rotational speed instruction for the rotational speed control is not executed, and the torque instruction for the torque control is not executed too.

When it is determined in step S101 that the intervention of the traction control is necessary, the necessity of executing the rotational speed control and the necessity of executing the torque control are determined.

In step S102, the necessity of executing the rotational speed control is determined based on the operating state of the motor 20 or the vehicle 101. When the traction control intervenes, it is basically determined that execution of the rotational speed control is necessary. However, for example, when a resolver that detects the rotational speed of the motor 20 has failed or when the vehicle body speed serving as a reference cannot be correctly estimated, it is determined that the rotational speed control is not to be executed. When it is determined that the rotational speed control is not to be executed, step S103 is skipped.

When it is determined in step S102 that the rotational speed control is to be executed, step S103 is executed. In step S103, the target rotational speed 52 calculated in step S113 is transmitted from the vehicle controller 40 to the motor controller 30. At the same time, an ON signal of the rotational speed control instruction flag is transmitted from the vehicle controller 40 to the motor controller 30, and the execution of the rotational speed control is instructed to the motor controller 30.

In step S104, the necessity of executing the torque control is determined based on the operating state of the vehicle 101 or the motor 20. Unlike the rotational speed control which is basically executed, the torque control is executed only when necessary. For example, when there is an intervention of stability control for stabilizing the behavior of the vehicle 101, such as skidding suppression control, the torque control is executed in conjunction with the intervention. Although reducing slip is one possible way to stabilize the behavior of the vehicle 101, in the traction control of the present disclosure, the motion of the vehicle 101 is controlled by controlling the driving forces acting on the wheels 12L and 12R. When it is determined that the torque control is not to be executed, steps S105 and S106 are skipped.

When it is determined in step S104 that the torque control is to be executed, steps S105 and S106 are executed. In step S105, based on the target driving force of the driving axle 10 set in step S123, the target torque of the driving axle 10 is set using the wheel radius stored in advance in the memory 44. In the case of a vehicle in which both the front axle and the rear axle are driving axles, the target torque is set for each driving axle based on the target driving force set for each drive axle.

Next, in step S106, the target torque set in step S105 is transmitted as the instruction torque 54 from the vehicle controller 40 to the motor controller 30. At the same time, an ON signal of the torque control instruction flag is transmitted from the vehicle controller 40 to the motor controller 30, and the execution of the torque control is instructed to the motor controller 30.

Finally, in step S107, the above-described torque arbitration is executed in the motor controller 30. In the case of a vehicle in which both the front axle and the rear axle are driving axles, the torque arbitration is executed for each driving axle. However, when only the ON signal of the rotational speed control instruction flag is input to the motor controller 30, only the rotational speed control based on the target rotational speed 52 is executed. When only the ON signal of the torque control instruction flag is input to the motor controller 30, only the torque control based on the instruction torque 54 is executed. When both the ON signal of the rotational speed control instruction flag and the ON signal of the torque control instruction flag are input to the motor controller 30, the torque lower limit guard or the torque upper limit guard described in “1. Overview of Traction Control” is executed.

### 2-3. Second Traction Control Method

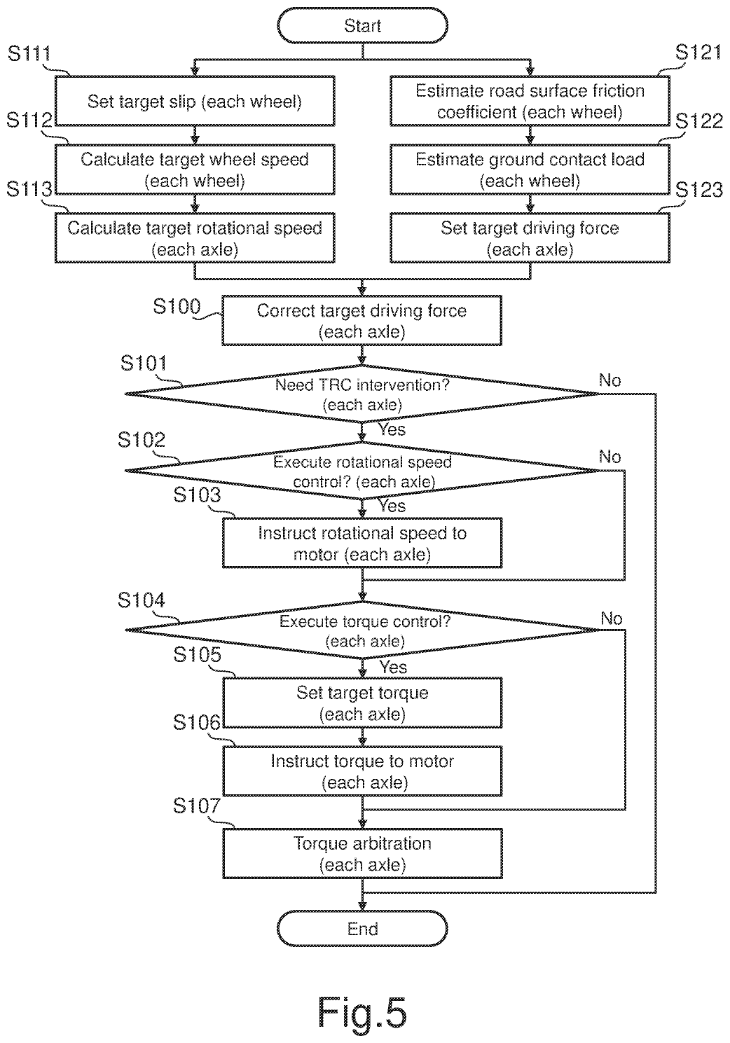

The second traction control method is another example of a specific method for executing the above-described traction control in the vehicle 101 having the configuration shown in FIG. 3. FIG. 5 is a flowchart of the second traction control method. Among the processes in the flowchart shown in FIG. 5, the same processes as those in the flowchart of the first traction control method are denoted by the same step numbers. In the following description, the processes already described in the description of the first traction control method will be simplified or omitted.

In step S111 of the flowchart, the target slip is set for each of the wheels 12L and 12R in accordance with the operating state of the vehicle 101. In step S112, the target wheel speed is calculated for each of the wheels 12L and 12R based on the target slip for each of the wheels 12L and 12R set in step S111. In step S113, the target rotational speed of the driving axle 10 is calculated from the average value of the target wheel speeds of the left and right wheels 12L and 12R calculated in step S112 and the wheel radius.

In step S121 of the flowchart, road surface friction coefficients between the wheels 12L and 12R and the road surfaces 2L and 2R are estimated. In step S122, ground contact loads between the wheels 12L and 12R and the road surfaces 2L and 2R are estimated. In step S123, target driving forces of the wheels 12L and 12R are set based on the road surface friction coefficients estimated in step S121 and the ground contact loads estimated in step S122, and the larger one of the target driving forces is set as the target driving force of the driving axle 10.

In the flowchart, the group of processes from step S111 to step S113 and the group of processes from step S121 to step S123 are executed in parallel, but it is also possible to execute either one group in advance and execute the other group thereafter.

Next, in the second traction control method, the process of step S100 is executed. In step S100, a deviation between the average value of actual slips of the left and right wheels 12L and 12R and the average value of the target slips of the left and right wheels 12L and 12R is calculated. Further, a deviation between the average value of wheel accelerations of the left and right wheels 12L and 12R and the average value of target wheel accelerations of the left and right wheels 12L and 12R is calculated. The wheel accelerations are obtained from the outputs of the wheel speed sensors 14L and 14R, and the target wheel accelerations are calculated from the target wheel speeds. Then, the target driving force is corrected by feedback control based on the slip deviation and the wheel acceleration deviation. In the correction by the feedback control, the correction gain is made variable according to the state of the vehicle 101. For example, in the straight-ahead state, only the correction gain for increasing the driving force may be increased, and the correction gain for decreasing the driving force may be maintained or decreased. Further, in the turning state, the correction gain for increasing the driving force may be decreased, and the correction gain for decreasing the driving force may be increased.

In step S101, the start and end of the intervention of the traction control are determined based on the slip states of the wheels 12L and 12R. When the intervention of the traction control is unnecessary, the rotational speed instruction for the rotational speed control is not executed, and the torque instruction for the torque control is not executed too. When it is determined that the intervention of the traction control is necessary, the necessity of executing the rotational speed control and the necessity of executing the torque control are determined.

In step S102, the necessity of executing the rotational speed control is determined based on the operating state of the motor 20 or the vehicle 101. When it is determined that the rotational speed control is not to be executed, step S103 is skipped.

When it is determined in step S102 that the rotational speed control is to be executed, step S103 is executed. In step S103, the target rotational speed 52 calculated in step S113 and an ON signal of the rotational speed control instruction flag are transmitted from the vehicle controller 40 to the motor controller 30.

In step S104, the necessity of executing the torque control is determined based on the operating state of the vehicle 101 or the motor 20. When it is determined that the torque control is not to be executed, steps S105 and S106 are skipped.

When it is determined in step S104 that the torque control is to be executed, steps S105 and S106 are executed. In step S105, the target torque of the driving axle 10 is set based on the target driving force of the driving axle 10 set in step S123. In step S106, the target torque set in step S105 is transmitted as the instruction torque 54 from the vehicle controller 40 to the motor controller 30, and an ON signal of the torque control instruction flag is transmitted too.

Finally, in step S107, the above-described torque arbitration is executed in the motor controller 30. Then, the motor 20 is controlled in accordance with the motor execution torque 56 obtained by the torque arbitration. Similar to the first traction control method, the second traction control method is also applicable to a vehicle in which both the front axle and the rear axle are driving axles.

### 3. Second Embodiment

3-1. Configuration of Electric Vehicle to which Traction Controller is Applied

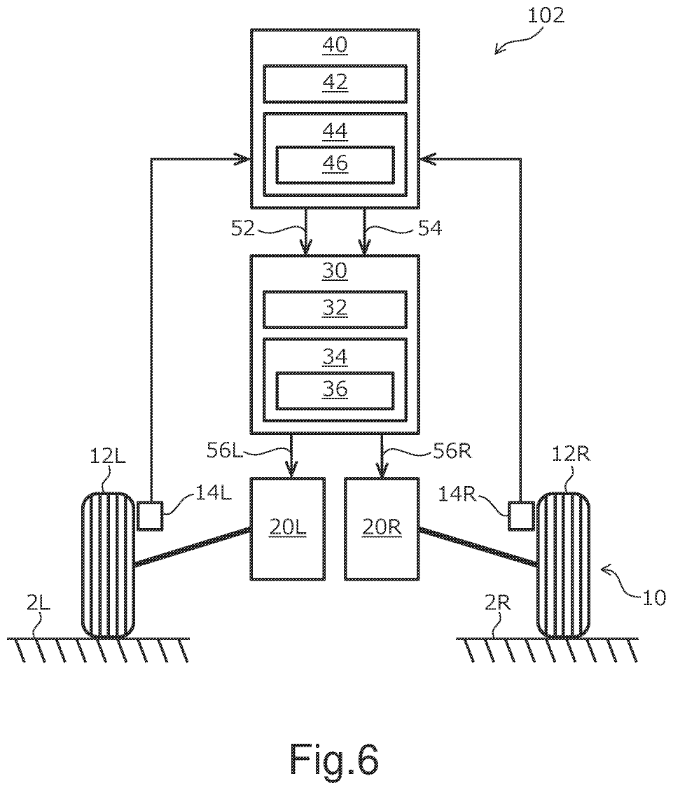

First, a configuration of an electric vehicle to which a traction controller according to the second embodiment of the present disclosure is applied will be described with reference to FIG. 6. In FIG. 6, the same components as those of the vehicle 101 according to the first embodiment shown in FIG. 3 are denoted by the same reference numerals. In the following description, a description of the configuration already described in the first embodiment will be simplified or omitted.

A vehicle 102 shown in FIG. 6 is an electric vehicle of the same type as the vehicle 101 of the first embodiment. The vehicle 102 is configured such that left and right wheels (driving wheels) 12L and 12R grounded on road surfaces 2L and 2R are driven by separate motors 20L and 20R, respectively. A reduction gear and a differential gear (not shown) are provided between the motor 20L and the left wheel 12L. Similarly, a reduction gear and a differential gear (not shown) are provided between the motor 20R and the right wheel 12R. The driving axle 10 provided with the wheels 12L and 12R may be a front axle or a rear axle. Further, both the front axle and the rear axle may be driving axles. In this case, a motor is provided for each of the left and right wheels of each of the drive axles, the front axle and the rear axle. Alternatively, the torque of one motor may be distributed to the front axle and the rear axle by a torque dividing mechanism.

The vehicle 102 includes a vehicle controller 40 and a motor controller 30. The program 46 stored in the memory 44 of the vehicle controller 40 includes a rotational speed control program and a torque control program. The program 36 stored in the memory 34 of the motor controller 30 includes a torque arbitration program. However, in the second embodiment, since the wheels 12L and 12R are driven by different motors 20L and 20R, respectively, there are differences between the contents of these programs and the contents of the programs in the first embodiment.

The vehicle controller 40 and the motor controller 30 constitute a traction controller according to the second embodiment. A target rotational speed 52 for rotational speed control and an instruction torque 54 for torque control are input from the vehicle controller 40 to the motor controller 30. However, in the first embodiment, the target rotational speed 52 and the instruction torque 54 are input for the driving axle 10, whereas in the second embodiment, the target rotational speed 52 and the instruction torque 54 are input for each of the left and right wheels 12L and 12R.

In the motor controller 30, torque arbitration is executed for each of the left and right wheels 12L and 12R. The motor execution torque 56L obtained by the torque arbitration for the left wheel 12L is input from the motor controller 30 to the motor 20L. The motor 20L operates in accordance with the motor execution torque 56L input from the motor controller 30. The motor execution torque 56R obtained by the torque arbitration for the right wheel 12R is input from the motor controller 30 to the motor 20R. The motor 20R operates in accordance with the motor execution torque 56R input from the motor controller 30.

### 3-2. Third Traction Control Method

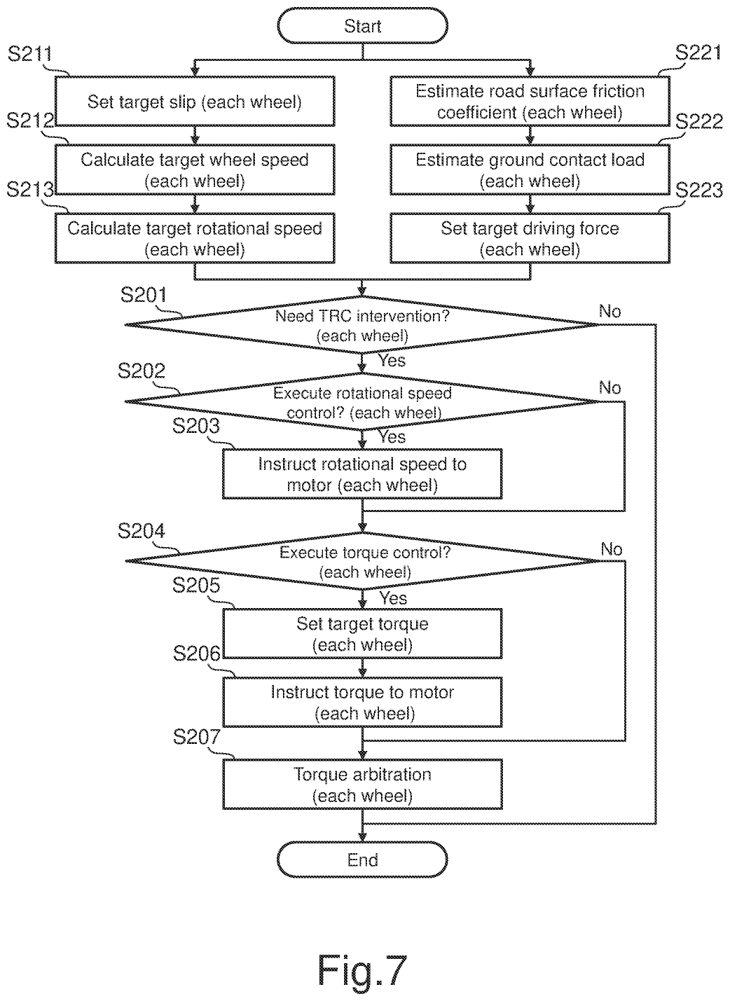

The third traction control method is an example of a specific method for executing the above-described traction control in the vehicle 102 having the configuration shown in FIG. 6. FIG. 7 is a flowchart of the third traction control method.

In step S211 of the flowchart, the target slip is set for each of the wheels 12L and 12R in accordance with the operating state of the vehicle 102. In the case of a vehicle in which all the wheels are driving wheels, the target slip is set for each of all the wheels.

In step S212, the target wheel speed is calculated for each of the wheels 12L and 12R based on the target slip for each of the wheels 12L and 12R set in step S211. In the case of a vehicle in which all the wheels are driving wheels, the target wheel speed is calculated for each of all the wheels.

In step S213, the target rotational speed is calculated for each of the wheels 12L and 12R from the target wheel speed for each of the wheels 12L and 12R calculated in step S212 and the wheel radius for each of the wheels 12L and 12R. In the case of a vehicle in which all the wheels are driving wheels, the target rotational speed is calculated for each of all the wheels.

In step S221 of the flowchart, road surface friction coefficients between the wheels 12L and 12R and the road surfaces 2L and 2R are estimated. In the case of a vehicle in which all the wheels are driving wheels, the road surface friction coefficient is estimated for each of all the wheels.

In step S222, ground contact loads between the wheels 12L and 12R and the road surfaces 2L and 2R are estimated. In the case of a vehicle in which all the wheels are driving wheels, the ground contact load is estimated for each of all the wheels.

In step S223, the available longitudinal force for each of the wheels 12L and 12R is estimated based on the road surface friction coefficients estimated in step S221 and the ground contact loads estimated in step S222. Then, the target driving force is set for each of the wheels 12L and 12R based on the available longitudinal force, the driver request driving force, and the vehicle state. In the case of a vehicle in which all the wheels are driving wheels, the target driving force is estimated for each of all the wheels.

In the flowchart, the group of processes from step S211 to step S213 and the group of processes from step S221 to step S223 are executed in parallel, but it is also possible to execute either one group in advance and execute the other group thereafter.

Next, in step S201, the start and end of the intervention of the traction control are determined based on the slip states of the wheels 12L and 12R. When the intervention of the traction control is unnecessary, the rotational speed instruction for the rotational speed control is not executed, and the torque instruction for the torque control is not executed too. The necessity of the intervention of the traction control is determined for each of the wheels 12L and 12R. In the case of a vehicle in which all the wheels are driving wheels, the necessity of intervention of traction control is determined for each of all the wheels. When it is determined that the intervention of the traction control is necessary, the necessity of executing the rotational speed control and the necessity of executing the torque control are determined.

In step S202, the necessity of executing the rotational speed control is determined based on the operating state of the motor 20 or the vehicle 102. When it is determined that the rotational speed control is not to be executed, step S203 is skipped.

When it is determined in step S202 that the rotational speed control is to be executed, step S203 is executed. In step S203, the target rotational speed 52 for each of the wheels 12L and 12R calculated in step S213 is transmitted from the vehicle controller 40 to the motor controller 30. At the same time, an ON signal of the rotational speed control instruction flag is transmitted from the vehicle controller device 40 to the motor controller 30, and the execution of the rotational speed control is instructed to the motor controller 30.

In step S204, the necessity of executing the torque control is determined based on the operating state of the vehicle 102 or the motor 20. When it is determined that the torque control is not to be executed, steps S205 and S206 are skipped.

When it is determined in step S204 that the torque control is to be executed, steps S205 and S206 are executed. In step S205, based on the target driving force for each of the wheels 12L and 12R set in step S223, the target torque for each of the wheels 12L and 12R is set using the wheel radius stored in advance in the memory 44. In the case of a vehicle in which all the wheels are driving wheels, the target torque is set for each of all the wheels.

In step S206, the target torque for each of the wheels 12L and 12R set in step S205 is transmitted as the instruction torque 54 from the vehicle controller 40 to the motor controller 30. At the same time, an ON signal of the torque control instruction flag is transmitted from the vehicle controller 40 to the motor controller 30, and the execution of the torque control is instructed to the motor controller 30.

Finally, in step S207, the above-described torque arbitration is executed in the motor controller 30 for each of the wheels 12L and 12R. In the case of a vehicle in which all the wheels are driving wheels, torque arbitration is executed for each of all the wheels. However, when only the ON signal of the rotational speed control instruction flag is input to the motor controller 30, only the rotational speed control based on the target rotational speed 52 is executed. When only the ON signal of the torque control instruction flag is input to the motor controller 30, only the torque control based on the instruction torque 54 is executed. When both the ON signal of the rotational speed control instruction flag and the ON signal of the torque control instruction flag are input to the motor controller 30, the torque lower limit guard or the torque upper limit guard described in “1. Overview of Traction Control” is executed.

### 3-3. Fourth Traction Control Method

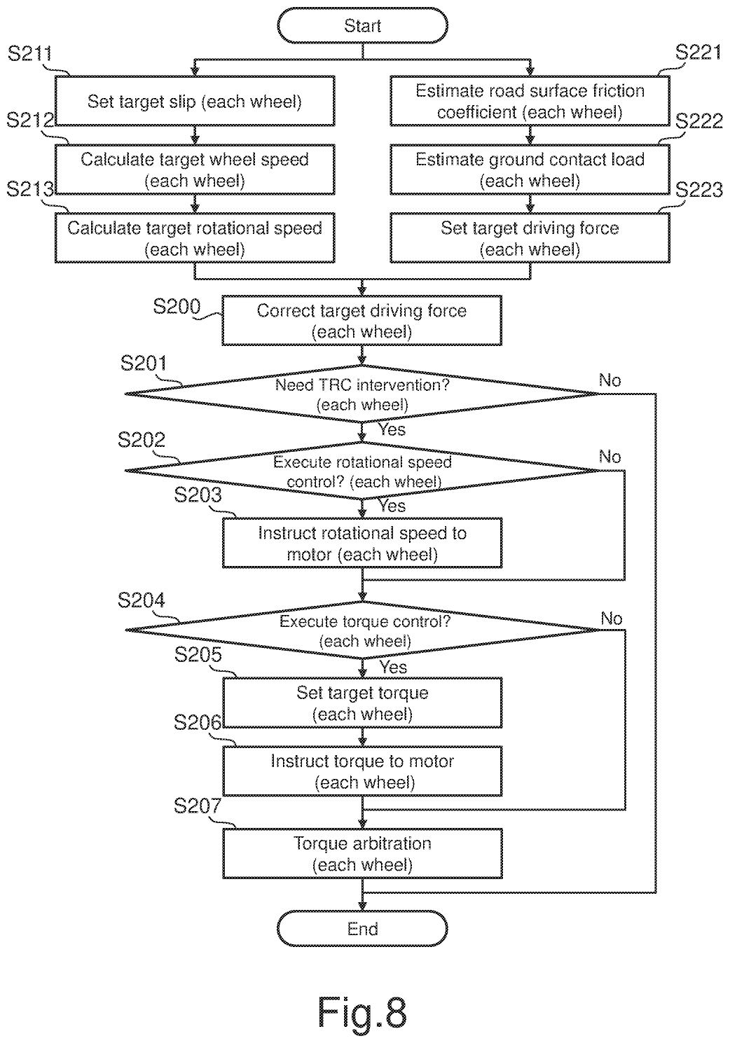

The fourth traction control method is another example of a specific method for executing the above-described traction control in the vehicle 102 having the configuration shown in FIG. 6. FIG. 8 is a flowchart of the fourth traction control method. Among the processes in the flowchart shown in FIG. 8, the same processes as those in the flowchart of the third traction control method are denoted by the same step numbers. In the following description, the processes already described in the description of the third traction control method will be simplified or omitted.

In step S211 of the flowchart, the target slip is set for each of the wheels 12L and 12R in accordance with the operating state of the vehicle 102. In step S212, the target wheel speed is calculated for each of the wheels 12L and 12R based on the target slip for each of the wheels 12L and 12R set in step S211. In step S213, the target rotational speed is calculated for each of the wheels 12L and 12R from the target wheel speed for each of the wheels 12L and 12R calculated in step S212 and the wheel radius.

In step S221 of the flowchart, road surface friction coefficients between the wheels 12L and 12R and the road surfaces 2L and 2R are estimated. In step S222, ground contact loads between the wheels 12L and 12R and the road surfaces 2L and 2R are estimated. In step S223, the target driving force is set for each of the wheels 12L and 12R based on the road surface friction coefficients estimated in step S221 and the ground contact loads estimated in step S222.

In the flowchart, the group of processes from step S211 to step S213 and the group of processes from step S221 to step S223 are executed in parallel, but it is also possible to execute either one of group in advance and execute the other group thereafter.

Next, in the fourth traction control method, the process of step S200 is executed. In step S200, a deviation between the actual slip and the target slip is calculated for each of the wheels 12L and 12R. Further, a deviation between the wheel acceleration and the target wheel accelerations is calculated for each of the wheels 12L and 12R. Then, the target driving force is corrected for each of the wheels 12L and 12R by feedback control based on the slip deviation and the wheel acceleration deviation. The correction gain of the feedback control is made variable in accordance with the state of the vehicle 102 as described in the second traction control method.

In step S201, the start and end of the intervention of the traction control are determined based on the slip states of the wheels 12L and 12R. When the intervention of the traction control is unnecessary, the rotational speed instruction for the rotational speed control is not executed, and the torque instruction for the torque control is not executed too. When it is determined that the intervention of the traction control is necessary, the necessity of executing the rotational speed control and the necessity of executing the torque control are determined.

In step S202, the necessity of executing the rotational speed control is determined based on the operation state of the motor 20 or the vehicle 102. When it is determined that the rotational speed control is not to be executed, step S203 is skipped.

When it is determined in step S202 that the rotational speed control is to be executed, step S203 is executed. In step S203, the target rotational speed 52 for each of the wheels 12L and 12R calculated in step S213 and an ON signal of the rotational speed control instruction flag are transmitted from the vehicle controller 40 to the motor controller 30.

In step S204, the necessity of executing the torque control is determined based on the operation state of the vehicle 101 or the motor 20. When it is determined that the torque control is not to be executed, steps S205 and S206 are skipped.

When it is determined in step S204 that the torque control is to be executed, steps S205 and S206 are executed. In step S205, the target torque for each of the wheels 12L and 12R is set based on the target driving force for each of the wheels 12L and 12R set in step S223. In step S206, the target torque for each of the wheels 12L and 12R set in step S205 is transmitted as the instruction torque 54 from the vehicle controller 40 to the motor controller 30, and an ON signal of the torque control instruction flag is transmitted too.

Finally, in step S207, the above-described torque arbitration is executed in the motor controller 30 for each of the wheels 12L and 12R. Then, the motor 20L for driving the wheel 12L is controlled in accordance with the motor execution torque 56L obtained by the torque arbitration for the wheel 12L. Further, the motor 20R for driving the wheel 12R is controlled in accordance with the motor execution torque 56R obtained by the torque arbitration for the wheel 12R. Similar to the third traction control method, the fourth traction control method is applicable to a vehicle in which all wheels are driving wheels.

### 4. Others

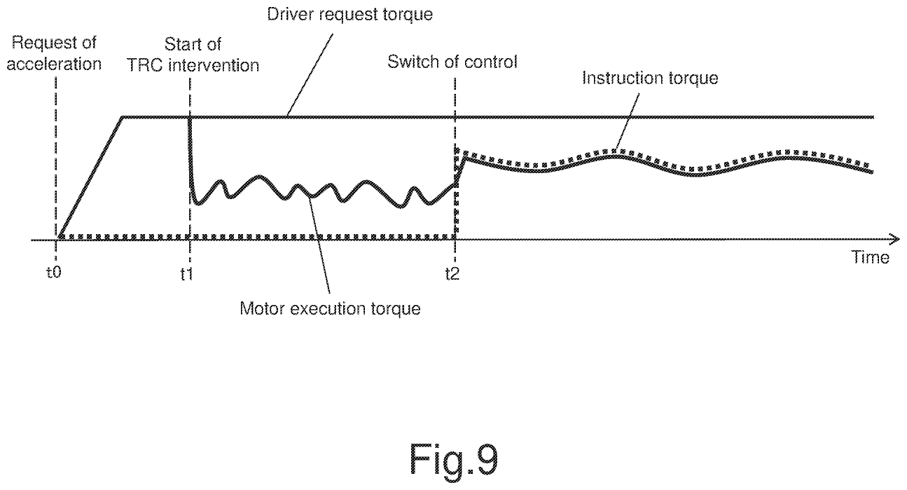

The vehicles 101 and 102 configured shown in FIGS. 3 and 6 can also execute traction control as shown in FIG. 9, for example. In the example shown in FIG. 9, after the intervention of the traction control at time t1, the rotational speed control is executed until time t2, and the rotational speed control target torque is output as the motor execution torque. Then, at time t2, the rotational speed control is switched to the torque control, and after time t2, the instruction torque of the torque control is output as the motor execution torque. Such traction control is executed when the rotational speed control cannot be executed, for example, when a resolver that detects the rotational speed of the motor 20 fails or when the vehicle body speed serving as a reference cannot be correctly estimated.

What is claimed is:

1. A traction controller for an electric vehicle that drives a wheel by a motor, the traction controller comprising:
at least one memory storing at least one program; and
at least one processor coupled to the at least one memory,
wherein the at least one program is configured to cause the at least one processor to:
set a target slip based on an operating state of the electric vehicle;
calculate a target rotational speed of the wheel based on the target slip;
calculate a first target torque that is a motor torque for achieving the target rotational speed;
set a target driving force of the wheel based on an estimated friction coefficient of a road surface and a ground contact load;
calculate a second target torque that is a motor torque for achieving the target driving force;
determine an arbitration target torque with the first target torque as a required value and the second target torque as a constraint condition; and
control the motor based on the arbitration target torque.

2. The traction controller for an electric vehicle according to claim 1,
wherein the at least one program is configured to cause the at least one processor to
correct the target driving force based on at least one of a deviation between the target slip and an actual slip and a deviation between a target wheel acceleration calculated from a target wheel speed for achieving the target slip and an actual wheel acceleration.

3. The traction controller for an electric vehicle according to claim 1,
wherein the determining the arbitration target torque includes executing a torque upper limit guard in which the first target torque is determined as the arbitration target torque when the first target torque is equal to or less than the second target torque, and the second target torque is determined as the arbitration target torque when the first target torque is greater than the second target torque.

4. The traction controller for an electric vehicle according to claim 3,
wherein the calculating the second target torque includes calculating a motor torque for stability control for stabilizing a behavior of the electric vehicle as the second target torque, and
the determining the arbitration target torque includes performing the torque upper limit guard in response to intervention of the stability control.

5. The traction controller for an electric vehicle according to claim 1,
wherein the determining the arbitration target torque includes executing a torque lower limit guard in which the first target torque is determined as the arbitration target torque when the first target torque is equal to or greater than the second target torque, and the second target torque is determined as the arbitration target torque when the first target torque is less than the second target torque.

6. The traction controller for an electric vehicle according to claim 5,
wherein the calculating the target rotational speed includes calculating, as the target rotational speed, a rotational speed of the wheel required to achieve the target slip based on a measured value or estimated value of a vehicle body speed, and
the determining the arbitration target torque includes executing the torque lower limit guard in response to the measured value or estimated value of the vehicle body speed used for calculating the target rotational speed not satisfying allowable accuracy.

7. The traction controller for an electric vehicle according to claim 1,
wherein the electric vehicle includes the motor for each driving axle that transmits a driving force to left and right driving wheels, and
the at least one program is configured to cause the at least one processor to:
calculate the target rotational speed for each driving axle;
calculate the first target torque for each driving axle;
set the target driving force for each driving axle;
calculate the second target torque for each driving axle;
determine the arbitration target torque for each driving axle; and
control the motor for each driving axle.

8. The traction controller for an electric vehicle according to claim 1,
wherein the electric vehicle includes the motor for each driving wheel, and
the at least one program is configured to cause the at least one processor to:
calculate the target rotational speed for each driving wheel;
calculate the first target torque for each driving wheel;
set the target driving force for each driving wheel;
calculate the second target torque for each driving wheel;
determine the arbitration target torque for each driving wheel; and
control the motor for each driving wheel.

9. A method for traction control for an electric vehicle that drives a wheel by a motor, the method comprising:
setting a target slip based on an operating state of the electric vehicle;
calculating a target rotational speed of the wheel based on the target slip;
calculating a first target torque that is a motor torque for achieving the target rotational speed;
setting a target driving force of the wheel based on an estimated friction coefficient of a road surface and a ground contact load;
calculating a second target torque that is a motor torque for achieving the target driving force;
determining an arbitration target torque with the first target torque as a required value and the second target torque as a constraint condition; and
controlling the motor based on the arbitration target torque.

10. A non-transitory computer-readable storage medium storing a program for traction control for an electric vehicle that drives a wheel by a motor, the program being configured to cause a computer to execute processing comprising:
setting a target slip based on an operating state of the electric vehicle;
calculating a target rotational speed of the wheel based on the target slip;
calculating a first target torque that is a motor torque for achieving the target rotational speed;
setting a target driving force of the wheel based on an estimated friction coefficient of a road surface and a ground contact load;
calculating a second target torque that is a motor torque for achieving the target driving force;
determining an arbitration target torque with the first target torque as a required value and the second target torque as a constraint condition; and
controlling the motor based on the arbitration target torque.
